(19) United States
(12) Patent Application Publication
(10) Pub. No.: US 2008/0063752 A1
(43) Pub. Date: Mar. 13, 2008

(54) Product Which is Fermented Without Lactose From a Shake Comprising Non-Vegetable Dried Fruits and/or Orgeat

(76) Inventors: Gaspar Perez Martinez, Burjassot (ES); M. Carmen Miralles Aracil, Paterna (ES); Adolfo Marti Vidagany, Bujassot (ES); Isabel Martinez, Paterna (ES)

Correspondence Address: WENDEROTH, LIND & PONACK, L.L.P., 2033 K STREET N. W., SUITE 800, WASHINGTON, DC, 20006-1021, US

(21) Appl. No.: 11/587,975

(22) PCT Filed: Apr. 27, 2005
(86) PCT No.: PCT/ES05/70053

§ 371 Date: Jun. 18, 2007

(30) Foreign Application Priority Data
Apr. 30, 2004 (ES) P200401043

(51) Int. Cl. A23B 7/10

(52) U.S. Cl. 426/49

(57) ABSTRACT

The invention relates to products which are fermented with probiotic lactic bacteria from milk or a shake comprising almonds (Prunus Amygdalus, var. dulcis), other tree nuts or orgeat obtained from chufa tubers (Cyperus esculentus). The inventive products deliver the nutritional benefits of the tree nuts, the chufa orgeat and the added probiotic bacteria, with a unique flavour and a consistency, acidity and aroma similar to yoghurt. Optionally, if the sugar content is kept low, the products have astringent and intestinal flora re-establishment properties. In addition, the products can be combined with additives and flavours and enriched with minerals, vitamins, fibre or oligosaccharides having a bifidogenic effect, etc., or pasteurised following fermentation. In almost all cases, the products constitute an excellent nutritional supplement for adolescents, athletes or elderly persons.

### SECTOR OF THE ART

Dairy industry, processing of tree nuts, production of chufa orgeat, production of almond milk, milk desserts.

### STATE OF THE ART

In regions with a dry temperate climate, there exist few dairy farms, as a result of which, evidently, milk for being drunk fresh does not form part of their cultural heritage. Nevertheless, numerous drinks have traditionally been prepared on the basis of vegetable products of great nutritional value and notable organoleptic qualities, standing out among which are almond milk and chufa orgeat.

The consumption of almonds and derivative products have been tied to the culture of these Mediterranean climate regions since pre-Roman times, constituting a food of high nutritional and energy value. Its biochemical composition varies little among the numerous known varieties: the lipid fraction is rich in polyunsaturated fatty acids, and it therefore possesses anticholesterolaemic properties, its proteins are highly digestible and the main carbohydrate it contains is saccharose (Características físico-químicas y tecnológicas de la almendra de la Comunidad Valencia (1999), Monografías. Vols I, II and III.- AINIA, Valencia). Its sensorial qualities are excellent since it has a unique and characteristic flavour.

On account of its nutritional properties “almond milk” has been known and used since ancient times in substitution baby food, as a dietary complement for women during lactation and for the elderly, and also for its cosmetic properties. Bearing in mind the average percentage composition of the tree nut (Table 1), almond milk (or shake) with a content in dry matter of 10-15% can in nutritional terms come close to cow milk, with a slight excess of fat and deficiency in sugars. Nevertheless, the mineral content of cow milk is still very much greater (Table 2).

TABLE 1
Comparison of the average content in nutrients
of the main varieties of almond with cow milk.

| COMPOSITION | ALMOND (DRY WEIGHT) (a) | | COW MILK (b) | |
|---|---|---|---|---|
| FAT g/100 g | 53-55 (60-74% oleic, | | 4 (30-40% oleic, | |
| | 20-32% linoleic) | | 25-30% linoleic) | |
| PROTEIN g/100 g | 19-21 | | 3.4 | |
| SUGARS g/100 g | 3.5-4.2 | | 4.5-5 | |
| MOST ABUNDANT VITAMINS | Vit E (tocopherol) | 250-400 | Vit A | 0.02-0.2 |
| mg/kg | Vit B1 (thiamine) | 2.1 | Vit D | 0.0002 |
| | Vit B2 (riboflavin) | 7.5 | Vit C | 0-5-20.8 |
| | Vit B3 (niacin) | 31.0 | Vit B2 | 0.2 |
| | Vit B5 (pantothenate) | 4.4 | Vit B6 | 0.015 |
| | Vit B6 | 1.5 | | |

| | | |
|---|---|---|
| ENERGY | 2431 kJ/581 kCal (per 100 | 2900 kJ/690 kCal (per |
| | g) | litre) |

SOURCES:
(a) Características físico-químicas y tecnológicas de la almendra de la Comunidad Valencia (1999), Monografías. Vols I, II and III. - AINIA, Valencia); USDA National Nutrient Database for Standard Reference, Release 16 (July 2003).
(b) Milk and Dairy product technology (1998) (ed. E: Spreer) Marcel Deckker, Inc, New York, USA.

TABLE 2
Comparison of the average mineral content of the main
varieties of almond with cow milk (mg/100 g).

| | Almonds ^{(a)} | |
|---|---|---|
| Composition | (dry weight) | Cow milk ^{(b)} |
| Potassium | 763.3 | 145 |
| Calcium | 270.5 | 125 |
| Phosphorus | 574.8 | 75 |
| Magnesium | 291.3 | 13 |
| Sodium | 10.2 | 50 |
| Manganese | 1.8 | — |
| Iron | 4.8 | 310 |
| Cobalt | 1.5 | — |
| Zinc | 4.4 | — |

SOURCES:
^{(a)} Características físico-químicas y tecnológicas de la almendra de la Comunidad Valencia (1999), Monografías. Vols I, II and III. - AINIA, Valencia); USDA National Nutrient Database for Standard Reference, Release 16 (July 2003).
^{(b)} Milk and Dairy product technology (1998) (ed. E: Spreer) Marcel Deckker, Inc, New York, USA.

Today, there exist numerous companies which distribute liquid products manufactured exclusively on the basis of almonds, hazelnuts or other tree nuts, which legally cannot be called milk and so the terms shake, milk-like, etc. are used. The oldest commercial product in this range could be almond cream or concentrate, which is a paste of finely ground almonds ready for being dissolved in water by the consumer and which keeps well thanks to its high concentration of added sugar (40%). Nevertheless, there is no record that any publications or registered commercial product prepared by fermenting this substrate exist.

In the Mediterranean Basin and North Africa the tubers of Cyperus sculentus are cultivated and consumed as a tree nut. In Spain they are known as “chufa” and in English also “earth almond” or “tigernut” as well as “chufa”, and it is used to prepare orgeat, which in olden times used to be known as chufa milk. This chufa extract possesses a high content of starches and sugars (Table 3), as well as a high proportion of polyinsaturated fatty acids (mainly oleic acid).

TABLE 3
Nutritional value of orgeat from chufa (tigernut, Cyperus sculentus)
COMPOSITION OF ORGEAT

| | AVERAGE | |
|---|---|---|
| | EXPERIMENTAL | LEGAL |
| | VALUES ^{(a)} | LIMITS ^{(b)} |
| STARCH | 2.42% | >1.9% |
| CHUFA SUGARS | 2-2.5% | |
| ADDED SUGARS | 10-15% | |
| TOTAL CARBO- | | >10% |
| HYDRATES | | |
| FAT | 2.62% | >2% |
| | | (vegetable) |
| Fatty acids: | | |
| Palmitic | 12.4% | |
| (C16) | 2.44% | |
| Stearic (C18) | 74.67% | |
| Oleic (C18:1) | 9.45% | |
| Linoleic (C18:2) | 0.35% | |
| Linolenic (C18:3) | | |
| PHOSPHOLIPIDS | 5.44% | |
| PROTEINS | 0.55% | 0.35% |
| ASH | 0.22 | 0.10% |
| FIBRE | | 0.38% |
| ENERGY | | 760 cal |
| VALUE (litre) | | |
| TOTAL SOLIDS | 22.82% | |
| SOLUBLE SOLIDS | 8% | 12% |
| Mg (ppm) | 154 | |
| K (ppm) | 554 | |
| P (ppm) | 280 | |
| pH | | >6.3 |

SOURCES:
^{(a)} La horchata de chufas: higienización, estabilización y tipificación (1985) Editores: B. Lafuente, F. Gasque, F. Piñaga, R. Vila. Instituto de Agroquímica y Tecnología de Alimentos (CSIC) ISBN: 84-00-06072-5.
^{(b)} Royal Decree 1338/1998, of 28 Oct. 1988, approving the technical-health regulations for the preparation and sale of orgeat of chufa.

The traditional preparation of orgeat from chufa starts with the washing and germicidal treatment of the chufa. Once rinsed, they are then put in soak for a period of time, rinsed again and then crushed in a mill. During crushing, approximately 3 litres of water are added per kilo of chufa, and it is then passed through a press to obtain the first extract and sieved. The residue from the sieve and the press are mixed together, with around two litres of water being added per kg of chufa, and it is passed through a press and sieved in order to form a second extract which is added to the first, with which the final extract is obtained. Finally, the preparation process for the orgeat is completed by dissolving the desired proportion of cane sugar (saccharose), generally between 100 and 150 grams per litre of extract, and it is sieved again (summary procedure, according to the Regulating Council for Orgeat of Chufa of Valencia, www.chufadevalencia.org/ESP/HORCHATA). It is traditionally drunk on a seasonal basis and fresh, though there are numerous commercial firms which distribute this product throughout the year, pasteurised, sterilised or frozen. It possesses very characteristic organoleptic properties, nevertheless, its high content in insoluble starches and the lack of natural emulsifiers in this product to a large degree make it difficult to conserve cold and retain its stability following heat treatment. No register of fermented products obtained starting from chufa orgeat exists.

Owing to problems of lactose intolerance and allergies to milk proteins, and to a considerable saturation of the market, an increase can be seen in researches and publications in which the use is described of fermentation substrates having a vegetable origin. Nevertheless, in none of them is almond milk, or milk of tree nuts or chufa orgeat used as the raw material [Martensen, O., Öste, R. and Obst, H. (2002) Texture promoting capacity and EPS formation by lactic acid bacteria in three different oat-based non-dairy media. Eur Food Res Technol 214: 232-236; Kovalenko, I V: Briggs, J L (2002) Textural characterization of soy-based yogurt by the vane method. Journal of Texture Studies 33 (2) 105-118; Ashay, O A; Taiwo, L B; Fasoyiro, S B; Akinnagbe, C A (2001) Compositional and shelf-life properties of soy-yogurt using two starter cultures. Nutrition and Food Science; 31 (5) 247-250; Yazici, F; Alvarez, V B; Hansen, P M T (1997) Fermentation and properties of calcium-fortified soy milk yogurt. Journal of Food Science; 62 (3) 457-461; Heenan, C N; Adams, M C; Hosken, R W; Fleet, G H (2002) Growth medium for culturing probiotic bacteria for applications in vegetarian food products. Lebensmittel Wissenschaft und Technologie; 35 (2) 171-176]. A series of dairy substitutes and fermented products of vegetable, legume origin, primarily soy, have also burst into the market (especially in natural, organic and vegetarian food stores), in spite of their organoleptic shortcomings and certain problems of allergies deriving from their protein.

There exist patents that registered the use of vegetable proteins as the basis for a dairy fermentation.

For example, application US2003031756: Method for preparing food products by fermenting soy milk with Streptococcus thermophilus. Boufassa Corinne; Tourancheau Myriam, 2003-02-13, GERVAIS DANONE SA (US), contains a method for obtaining a new type of product with reduced post-acidification, by fermentation with Streptococcus thermophilus or other lactic bacteria, starting from soy milk as base (50%), to which other components are added, such as grain flours or almond milk. Its different composition will grant it intrinsically different properties from the product described in this invention.

For example, patent CN1385082 Lactic acid drink having almond protein and preparation process thereof. Ma Jing. 2002-12-18, presents an acid drink obtained starting from milk and almond milk as raw material, which is subjected to lactic fermentation. This drink is described with beneficial properties for health and an agreeable flavour. Nevertheless, it possesses milk, something which is sought to be avoided in vegetarian diets, or if a person has allergies or intolerance to the components of milk.

For example, the application CN1270217: Green-series functional beverages An Guoqing, 2000-10-18, also describes the use of fermented milk as a starting product to which are added shakes or extracts of walnut, peanut, black sesame, almond, chrysanthemum flower, etc., with the aim of improving its content in nutrients or promoting its absorption, preventing or curing illnesses. As has been mentioned, in the invention that is described further below, the aim has been to avoid the use of milk.

Moreover, a considerable boom in what are known as “Functional Foods” exists, some of which are so-called because they contain microorganisms classified as probiotic. These are microorganisms which, beyond their mere nutritional input, exert beneficial effects on one or more organs, improving the general state of health, or reducing the risk of contracting illnesses [American Journal of Clinical Nutrition (2001) Special issue on Prebiotics and Probiotics, Feb; Vol 73 (2 Suppl)]. More specifically, the following effects of “functional” bacteria (probiotics) have been demonstrated: they reduce the lactose content of dairy products, they promote degradation of cholesterol and bile salts, they improve both local and the systemic immunological response, they inhibit proliferation of pathogens, they produce numerous beneficial metabolites and vitamins, and they help to eliminate carcinogenic compounds. Although foods containing them are classified as Functional Foods, in many countries they cannot be called yoghurts since, for example, and according to the Spanish Food CODEX, “yoghurt is a fermented product made with milk (of cow or other animal) which contains a minimum of 10⁷ ufc/ml of Streptococcus salivarius subsp thermophilus and Lactobacillus delbruekii subsp bulgaricus.”

### DESCRIPTION OF THE INVENTION

### BREIF DESCRIPTION OF THE INVENTION

This invention describes how to exploit the nutritional richness and sensorial qualities of almond, tree nuts and chufa orgeat, in order to prepare products fermented with lactic bacteria and probiotics. Products have been obtained that are above all tasty, with multiple beneficial effects on health: those derived from almond and tree nuts (polyunsaturated fatty acids, proteins with easy digestibility, low sugar content) and the probiotic properties of the bacteria that are used. These exclude the presence of milk proteins, lactose and soy proteins, avoiding problems of intolerance and allergies, as well as their taste of bean (soy). Also, these products can be sweetened or enriched with certain minerals (Fe, Ca), vitamins, fibre or oligosaccharides with bifidogenic effect., etc. Due also to their high content in potassium and magnesium, these products constitute an excellent nutritional complement for specific population sectors, such as children, adolescents, athletes or the elderly.

### DETAILED DESCRIPTION OF THE INVENTION

This invention consists of a range of products obtained by lactic fermentation of drinks, of vegetable origin, traditional in Mediterranean Europe and North Africa, as might be milk (or shake) of almonds and orgeat, as well as other new products of a similar nature obtained from other tree nuts. Both almond milk and chufa orgeat are products very rich in nutrients, though with a different composition. The deliberate absence of milk, soy and derivatives of both in these new products will avoid problems of intolerance and allergies to them. Moreover, these new products offer different basic flavours which exclude the dairy flavour as well as the pronounced bean flavour of soy bean and its derivatives. In the product obtained, the coliform counts are zero and it possesses low post-acidification, in other words the pH drops by less than 0-1-0.2 pH units in 28 days. To these products substances and additives can be added in order to obtain products possessing very diverse physico-chemical, nutritional and sensorial characteristics. So, all or part of the oil of the almond, which is valuable in itself, can be eliminated in order to obtain low-fat derivatives and to standardise the product.

Almond, Tree Nuts Milk (or Shake) and Chufa Orgeat

It is very important to obtain a mother liquor containing sugars that can be fermented by the lactic acid bacteria that are going to be used as starters, as well as proteins and additives, in such a way that a good texture and viscosity is obtained in the final fermented product (equivalent to that of traditional yoghurt, drinkable yoghurts or fermented milks). Also, the starting mother liquor has to have a high microbiological quality, at least equivalent to pasteurised cow milk (pathogen and enterobacteria counts=0; total mesophiles<10²), since it will normally be subjected to temperatures of 30-37° C. during the fermentation. To achieve this, all processes must be carried out under strict hygienic conditions. The process starts with crushing, which can be done in one or more phases. If it is done in a single phase, the sugars and additives are added beforehand. If a preliminary coarse crushing is done first, the sugars and other additives are added after this first phase, prior to the fine grinding. For the fine grinding, a stone or colloidal mill is used until a suspension is obtained having the texture that is sought, which can be from smooth to lumpy, with the concentration of dry matter also being adjusted according to taste. After that, extraction (or addition) of fatty acids and oils is then carried out followed by its homogenisation. In the trials conducted, additives are added prior to fine grinding since it suited our conditions better, but they could also be added in other phases of the preparation.

The heat treatment is of fundamental importance for reducing bacterial counts and therefore ensuring hygienic quality, and is carried out following the grinding and homogenisation. The conditions of temperature, time and pressure will depend on the nature of the product (for example, almonds, hazelnuts, chufa, etc.), on the size of particles in suspension, its concentration of solids, viscosity, microbiological load prior to treatment and the stability of the components during heat treatment. This treatment can cause denaturation of the proteins, but it favours gelling of the actual almonds and also of the additives added for stabilising the product, such as xanthan gum, pectin, carob gum, acacia gum or other polymers. The trials with almond milk described in this patent were conducted on raw material pasteurised in our pilot plant, though the fermentation was also tested on a commercial product (almond shake, Diemilk, Nitriops) treated at high temperatures (UHT) with the same results. Also, the trials with hazelnut milk (shake) and chufa orgeat were conducted with products sterilised by the UHT method.

Fermentation.—The lactic bacteria and bifidobacteria used ferment lactose (disaccharide sugar from milk) and other sugars producing lactic acid (produces acidification), polysaccharides (give a gelatinous texture) and volatile compounds (contribute aromas). Both tree nuts and chufa possess sufficient mono- and disaccharide sugars (as glucose, fructose and saccharose) for being able to guarantee their fermentation, nevertheless, these can also be added before or after fine grinding in abundant quantity as fermentation substrate and as sweetener. Although lactose could also be added, in the examples that are described its presence is avoided since the product sought to be obtained must not contain lactose and, in spite of the fact that its elimination could be avoided, it was preferred to obviate the negative consequences which it entails for many consumers.

So far, trials have been carried out with highly satisfactory results using various lactic ferments of the species St. salivarius subsp thermophilus as well as this same bacterium St. salivarius subsp thermophilus together with Lactobacillus delbruekii subsp bulgaricus, Bifidobacterium lactis, Lactobacillis casei and Lactobacillus acidophilus. Other probiotic species can easily be incorporated to these products, such as Lactobacillus rhamnosus, Lactobacillus johnsonii, Lactobacillus fermentum or Lactobacillus reuteri. Likewise, almond milk can also be fermented with kefir inoculum, obtaining for example almond kefir or orgeat kefir. Kefir inoculum is not a single bacterium/yeast but instead a mixed culture and is also very variable in its composition of strains.

As is described in the examples, in order to obtain the necessary acidity (pH<4.6), the recommendable initial inoculum of St. salivarius subsp thermophilus is at around 10⁶-10⁷ cfu/ml and that of the probiotics (other species) is adjusted according to their fermenting potential and other factors related to their metabolic effects. Equally, the optimum temperature for incubation is 42° C. for St. salivarius subsp thermophilus but this can vary depending on the other species inoculated and the characteristics of the product.

The final product.—The safety of these products is guaranteed by the simple fact that all the components used for their preparation are habitually consumed and are authorised. So, as raw materials we will use traditionally consumed pasteurised or sterilised products (ground tree nuts or chufa orgeat, water and authorised food additives), to which are added starter cultures of dairy products and probiotics obtained from specialist companies, with the corresponding guarantees.

The products obtained possess a consistency similar to that of traditional yoghurt, drinkable yoghurts or fermented milks, in other words with viscosity values of between approximately 60 and 250 mPas/sec. depending on the starter culture and additives used. In this regard, according to the measurements made in our laboratory, one can differentiate between the milk fermented drinks with a lower degree of viscosity of from 37 to 155-160 mPas/sec (respectively from Natural Fermented Milk [Central Lechera Asturiana] and Dan'up [Danone]) and fermented yoghurts and milks for eating “with spoon”, which possess average values of 210 to 250 mPas/sec (Natural Yoghurt and Bio [Danone], La Lechera [Nestlé], etc.). However, this property can be adjusted to other values by means of the appropriate additives. They are above all tasty, with variable acidity according to the starter inoculi or probiotics used (caused by the formation of lactic acid) and a mild aroma and flavour of fermented dairy product (possibly due to the formation of diacetyl and acetaldehyde). This makes them suitable for being mixed with different products such as a variety of fruits, chocolate, honey, cereals, various kinds of essences and flavours which will be able to enormously expand the range of products derived from them, or which can be obtained by later mixtures.

The inclusion of probiotic bacterial species has the consequence that the product will possess multiple beneficial effects on health: those deriving from almond and tree nuts (polyunsaturated fatty acids, proteins with easy digestibility, high K⁺ content, low sugar content, etc.) or of chufa orgeat, and the probiotic properties of the bacteria that are used.

Given that microbial fermentation consumes a defined quantity of the dissolved sugar, products can be designed with different sugars and different quantities of them, in order to obtain products with different properties, such as their sweet taste or astringent capacity. Artificial sweeteners and non-metabolisable sugars (fructose, sorbitol, etc.) can also be used in the preparation of low calorie products or products for diabetics.

Also, these products can be enriched with certain minerals (Fe, Ca), vitamins, fibre or oligosaccharides with bifidogenic effect, etc., so that these products can meet the needs of specific population sectors, such as children, adolescents, athletes or the elderly.

A particular embodiment of this invention which would have a fair degree of importance would give rise to FERMENTED PASTEURISED PRODUCTS WITH “BIFIDUS” EFFECT but WHICH WILL NOT REQUIRE COLD CHAIN. This will be achieved by adding, among other additives, oligofructosaccharides or different starches to the almond milk mother liquor. Adjusting its concentration, and also that of other gelling agents (the oligofructosaccharides on their own have thickening properties) in order to obtain the desired viscosity. In this case, the initial fermentation will be carried out at least with one strain of S. salivarius subsp thermophilus and afterwards the product is pasteurised, being left ready for marketing. Although this product will lack lactic ferments and live probiotics, it will contribute major logistic and marketing advantages.

### BRIEF DESCRIPTION OF THE CONTENT OF THE FIGURES

FIG. 1: Evolution of pH during the fermentation of almond milk inoculated with 10⁷ ufc/ml of three strains of Streptococcus salivarius subsp thermophilus: BS5 (▪), BS9 (Δ) and BS127 (X). The control line represents the evolution of milk pH without inoculation with starters.

FIG. 2: Evolution of pH during fermentation of almond milk inoculated with 10⁸ ufc/ml of St. salivarius subsp thermophilus: BS5 (▪), St. salivarius: BS5 plus Bifidobacterium lactis BL230 (Δ) and St. salivarius with L. casei: BL227 (X). The control line represents the evolution of milk pH without inoculation with starters.

FIG. 3: Evolution of pH during fermentation of hazelnut milk inoculated with 10⁸ ufc/ml of St. salivarius subsp thermophilus: BS5 and Lactobacillus acidophilus BL228 (▪). The control line represents the evolution of milk pH without inoculation with starters.

FIG. 4: Evolution of pH during fermentation of orgeat of chufa (Cyperus sculentus) inoculated with 10⁸ ufc/ml of three strains of St. salivarius subsp thermophilus: BS5 and Lactobacillus acidophilus BL228. The control line represents the evolution of orgeat pH without inoculation with starters.

### EXAMPLE 1

### Obtaining a Product Fermented with St. salivarius subsp thermophilus Starting from Almond Milk

Materials used.—The almonds used were from the varieties Marcona and Ferraduel, with similar results being obtained in both cases. Different stabilising agents were tested (gelling agents or thickeners) such as carob gum, xanthan gum, acacia gum, maize starch, carragenate and pectin, in concentrations of 0.5% and 0.3%, with xanthane gum, acacia gum and carragenate being finally selected. The gelling agents and stabilisers are of a very varied nature and have a synergic effect. Different sugar concentrations were tested (from 10 to 77 g/l), the sugar at all times being saccharose (cane sugar).

Pilot plant equipment.—Steam drum (Groen), household mincer with glass vessel (Braun), colloidal mill (Fryma), homogeniser (Manton Gauli), tubular exchanger manufactured by Luzzysa, S. A. and automated by SUGEIN S. A. and laminar flow chamber (Telstar S. A.).

Other laboratory equipment.—Viscometer Tester VT5^{R} (Haake).

Microbiological methods.—The counts on a petri dish were made in the following culture media: Coliforms, VRBG at 42° C.; sulphite-reducing Clostridia, TSC-D-cycloserine at 42° C.; total mesophiles TSA at 37° C.; aerobic sporulates, LBA at 37° C., after warming for 10 minutes at 60° C., Streptococcus STA at 42° C.; Lactobacilli and Bifidobacterium lactis, MRS at 37° C.

Monitoring of acidification of the product during fermentation.—In order to monitor the fermentations, a pH and conductivity metering equipment was used (Consort) with 6 ports and connection to an R2332 port of a table-top computer.

1.—Obtaining a Homogenised and Pasteurised Almond Milk (or Shake).

First of all, a pasteurised substrate has to be obtained (free of contaminants and possible pathogens) with optimum properties for supporting the growth of lactic bacteria (lactic ferments), in such a way that the physical, nutritional and organoleptic properties of the product obtained following the fermentation are suitable.

Different batches of between 1 and 2 kg of shelled almonds were scalded in a drum of approximately 5 1 capacity. After being peeled by hand with hygienic gloves, they were subjected to a first coarse grinding in a mincer (Braun) after which water was added until a concentration of almonds was reached of 100 g/l, followed by additives in the following proportions: 66 g/l of cane sugar, 3 g/l of acacia gum, 3 g/l of xanthane gum and 3 g/l of I-carragenate. The mixture was then subjected to fine mincing in a colloidal mill until the product had a milky appearance, with a fine texture and without any fragments being perceptible to the palate.

It was then homogenised at 300 kg/cm² pressure. At this point, a control of the process was conducted with a bacterial count (Table 4, data “Before pasteurising”). It was then pumped into the tubular exchanger for being pasteurised. The heat treatment was conducted at atmospheric pressure for more than 6 minutes at 95° C. At this temperature, more prolonged treatments could cause breakage of the suspension, possibly due to denaturation of proteins. After pasteurisation, the second control was carried out with bacterial counts (Table 4). The data from the microbiological control of the process are shown in Table 4. The main conclusion is that the temperature has to be kept at 95° C. for more than 6.30 minutes in order to have total mesophile counts<10 cfu per millilitre. After that, the inoculi of the cultures are mixed into the product and a bacterial count is performed.

TABLE 4
Fine-tuning of parameters for the pasteurisation
process: bacterial counts and pH of almond milk

| | | PASTEURISATION CONDITIONS | | | Total mesophile | |
|---|---|---|---|---|---|---|
| | | Residence | | | counts cfu/ml | |
| | Initial | time | Temp | Flow l/h | Before | After |
| | pH | (min) | (° C.) | (QL) | pasteurising | pasteurising |
| 1^{ST} | 6.72 | 6.05 | 95-96 | 143.00 | 5.1 × 10⁶ | 1.2 × 10² |
| MANUFACTURE | | | | | | |
| 2^{ND} | 6.65 | 6.33 | 95-96 | 137.00 | 2.86 × 10⁵ | <10 |
| MANUFACTURE | | | | | | |
| 3^{RD} | 6.56 | 6.75 | 78-80 | 128.00 | 2.73 × 10⁵ | 1.2 × 10² |
| MANUFACTURE | | | | | | |
| 4^{TH} | 6.65 | 6.70 | 94-95 | 135.00 | 6.63 × 10³ | <10 |
| MANUFACTURE | | | | | | |
| 5^{TH} | 6.52 | 0.12 | 117 ± 2 | 158 | 1.2 × 10⁴ | <10 |
| MANUFACTURE | | | | | | |

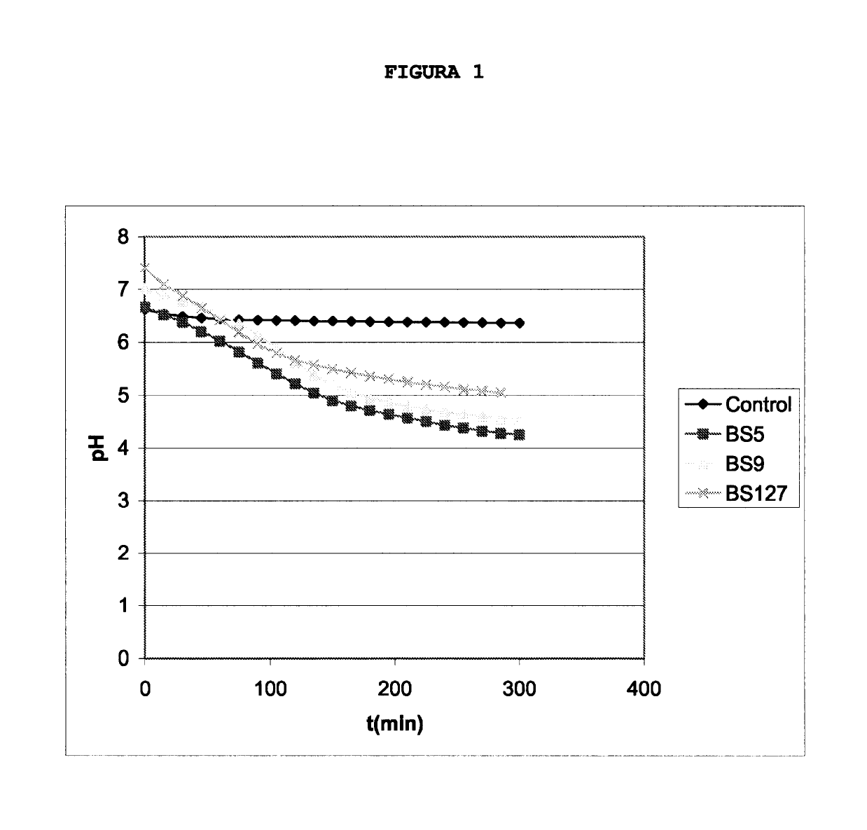

2.—Fermentation trial with St. salivarius subsp thermophilus. Although almond possesses 3.5 to 4.2% of simple fermentable sugars (Table 1), we wished to test the addition of other mono- and disaccharides (such as glucose, fructose and saccharose) in abundant quantity as fermentation substrate and sweetener. The efficiency of fermentation of these sugars will depend on the bacterial species and strains used. Prior knowledge of the fermenting capacity of different candidate lactic bacteria and the methods developed in our laboratory have enabled us to make a quick selection of those which produce acidification and formation of polysaccharides suitable for the type of product desired. At this point, the measurement of viscosity, bacterial counts and perishability is carried out. The trials conducted with various strains of the species St. salivarius subsp thermophilus were highly satisfactory (FIG. 1). It can be seen that with the three strains used the pH desired in these products can be reached (4.4-4.6), though with different fermentation times. As a consequence, the number of coliforms detected in this product was zero at all times.

### EXAMPLE 2

### Obtaining a Fermented Product Starting from Almond Milk with Probiotics

Once the first fermented product or BASE PRODUCT of the above example had been developed, the addition of probiotic bacteria was tested. Nowadays, the ones most used on a commercial basis are strains of the species: Bifidobacterium lactis, L. casei, L. rhamnosus, L. acidophilus, L. delbruekii subsp bulgaricus, L. johnsonii, L. fermentum and L. reuteri, among others. St. salivarius subsp. thermophilus itself which, along with Lactobacillus delbruekii subsp bulgaricus, is responsible for the fermentation of yoghurt, is frequently regarded as a probiotic in itself.

Each probiotic strain possesses its own metabolic characteristics. For that reason, certain conditions need to be adjusted, such as incubation temperature and the nature of the sugars that are added (see above), with the aim of obtaining products suitable for consumption and in which the probiotics are present in large numbers, since it is estimated that the minimum intake of a probiotic ought to be higher than 10⁹ bacteria per dose.

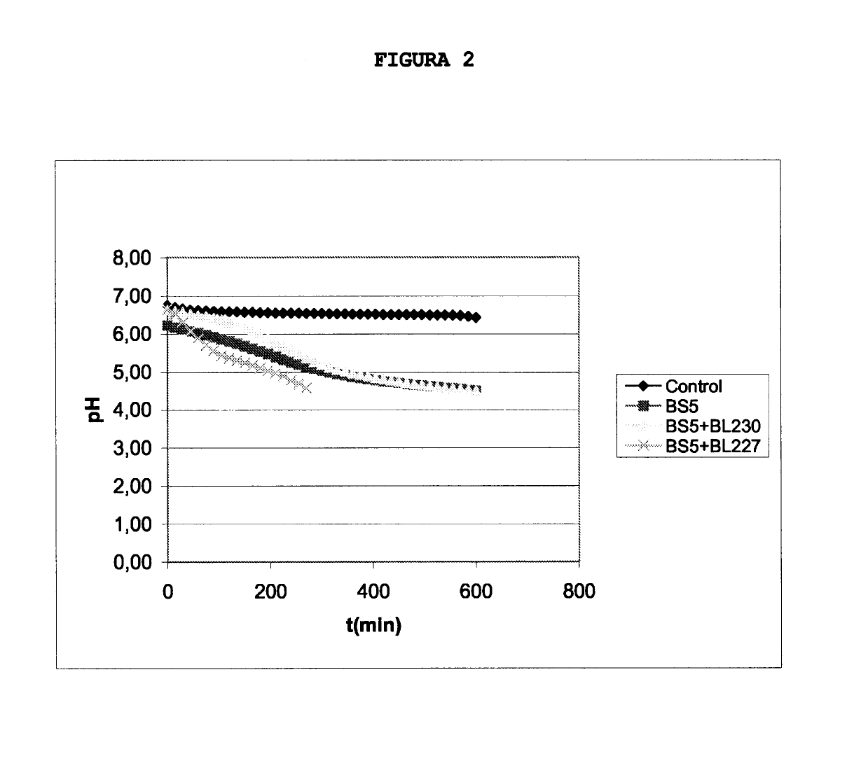

The co-inoculation of almond milk (of identical composition to that described above) with St. salivarius subsp thermophilus and also with three strains of the species: Bifidobacterium lactis, L. casei, and L. acidophilus were tested in independent experiments. On incubating at 37° C. in order to permit the growth of the probiotic strains, St. salivarius subsp thermophilus ferments and develops more slowly than at 42° C. (see FIG. 1). Nevertheless, the results show that addition of a new bacterium accelerates the fermentation process (FIG. 2), in all cases obtaining products with very suitable physico-chemical and sensorial characteristics (Table 5). Table 5 also shows the microbiological parameters of the process, demonstrating that there is a proliferation of inoculated bacteria in the almond milk. The properties of the product obtained are usually suitable, apart from inoculation with L. casei, in which case the sugar that is added or the inoculum ought to be modified in order to improve its commercial possibilities.

TABLE 5
Result of different fermentation tests on almond milk with different initiator starter cultures

| | FERMENTATION | | | | | | | | |
|---|---|---|---|---|---|---|---|---|---|
| | PARAMETERS | | | CONDITIONS | | CONDITIONS | | | |
| | STARTER | | | AT START | | AT END | | viscosity | |
| TRIAL | CULTURE | Temp | Time | COUNTS | pH | COUNTS | pH | mPas/sec | remarks |
| 1 | S. thermophilus | 42° C. | 5 h | 3.8 × 10⁷ | 6.63 | 3.29 × 10⁸ | 4.67 | 96-100 | Good |
| | BS5 | | | | | | | | flavour, |
| | | | | | | | | | creamy |
| 2 | S. thermophilus | 37° C. | 5 h | 3.25 × 10⁷ | 6.60 | 7.9 × 10⁷ | 4.52 | 195-205 | Good |
| | BS5 | | | | | | | | flavour, |
| | +B. lactis | | | 1.1 × 10⁷ | | 9.2 × 10⁷ | | | creamy |
| | BL230 | | | | | | | | |
| 3 | S. thermophilus | 37° C. | 4 h | 5.9 × 10⁷ | 6.53 | 6.43 × 10⁸ | 4.55 | 41.00 | Curdled |
| | BS5 | | 15 m | | | | | | appearance |
| | +L. casei | | | 1.4 × 10⁸ | | 8.3 × 10⁸ | | | |
| | BL227 | | | | | | | | |
| 4 | S. thermophilus | 37° C. | 4 h | 8.9 × 10⁶ | 6.52 | 9.3 × 10⁷ | 4.50 | 173-200 | Excellent |
| | BS5 | | 15 m | | | | | | flavour, |
| | +L. acidophilus | | | 1.5 × 10⁷ | | 6.6 × 10⁷ | | | smooth and |
| | BL228 | | | | | | | | creamy |

Conservation of the Viability and Post-Acidification of the Different Probiotics in Fermented Almond Milk.

With the aim of studying the viability of the probiotic bacteria introduced in these products over the course of storage time in refrigeration and display on cold shelves, the difference was determined between the number of viables at the start (day 1) and at 23-30 days of conservation in refrigeration (4° C.) in three fermentations containing St. salivarius subsp. thermophilus BS5, St. salivarius subsp. thermophilus BS5 and Lactobacillus acidophilus BL228 and St. salivarius subsp thermophilus BS5 and Bifidobacterium lactis BL230 (Table 6). As a conclusion, we can affirm that, although the St. thermophilus counts fell in all cases by around one order of magnitude, for Lactobacillus acidophilus and especially Bifidobacterium lactis they remained at virtually the same level of viability.

TABLE 6
Effect of incubation at 4° C. on viable counts of St.
salivarius subsp. thermophilus (BS5), Lactobacillus acid-
ophilus (BL228) and Bifidobacterium lactis (BL230), and
also on the pH, in each of the three fermentations of almond
milk made for studying its acidification when cold.

| | t (days) | BS5 | LB228 | LB230 | |
|---|---|---|---|---|---|
| Fermentation | storage | (cfu/ml) | (cfu/ml) | (cfu/ml) | pH |
| 1 | 1 | 1.2 · 10⁸ | | | 4.50 |
| | 23 | 1.73 · 10⁶ | | | 4.41 |
| 2 | 1 | 9.3 · 10⁷ | 6.6 · 10⁷ | | 4.50 |
| | 31 | 1.2 · 10⁷ | 1.9 · 10⁶ | | 4.38 |
| 3 | 1 | 1.05 · 10⁸ | | 7.3 · 10⁷ | 4.58 |
| | 30 | 5.3 · 10⁶ | | 7.3 · 10⁷ | 4.48 |

In relation to the negative phenomenon of continued acidification of the fermented products during storage (post-acidification), we have been able to confirm that the change is very small: of 0.10-0.13 pH units (Table 6).

### EXAMPLE 3

### Obtaining Fermented Products Starting from other Tree Nuts: Fermentation of a Hazelnut Shake

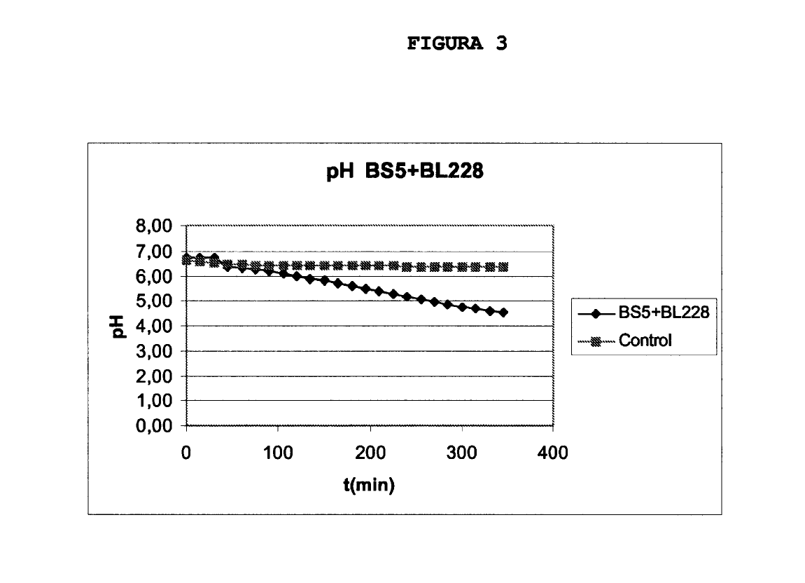

Hazelnuts and other tree nuts also possess small quantities of simple fermentable sugars, nevertheless, we wish to test the addition of saccharose in abundant quantities as fermentation substrate and sweetener. For the test that is described, we start from a hazelnut shake (Diemilk, Nutriops), sterilised at high temperature (UHT) with 7% of hazelnuts, maltodexrines and saccharose, giving the following composition per 100 g: carbohydrates, 6.3 g; sugars, 3.6 g; fats, 2.2 g (saturated, 0.6 g; monounsaturated, 1.2 g; polyunsaturated, 0.4 g); food fibre, 0.4 g; Na, 0.05 g. Inoculi of species St. salivarius subsp. thermophilus BS5 and L. acidophilus BL228 were added to this product and it was incubated at 37° C. (FIG. 3). An appropriate drop in pH (4.53) could be observed along with a good proliferation of the two inoculated bacteria, giving as a result excellent physico-chemical and sensorial characteristics (Table 4). So, the viscosity was estimated at 110 mPas (Table 7).

TABLE 7
Result of different fermentation trials on hazelnut shake (or
milk) with S. thermophilus BS5 and L. acidophilus BL228.

| | FERMENTATION | | | | | | | | |
|---|---|---|---|---|---|---|---|---|---|
| | PARAMETERS | | | CONDITIONS | | CONDITIONS | | | |
| | STARTER | | | AT START | | AT END | | viscosity | |
| TRIAL | CULTURE | Temp | Time | COUNTS | pH | COUNTS | pH | mPas/sec | remarks |
| | S. thermophilus | 37° C. | 5 h | 4 × 10⁶ | 6.7 | 3 × 10⁸ | 4.5 | 110 | Good |
| | BS5 | | 45 m | | | | | | flavour, |
| | L. acidophilus | | | 2.9 × 10⁷ | 1 | 1.16 × 10⁸ | 3 | | intense |
| | BL228 | | | | | | | | syneresis |

TABLE 8
Result of different fermentation trials on orgeat with
S. thermophilus BS5 and L. acidophilus BL228.

| | FERMENTATION | | | | | | | | |
|---|---|---|---|---|---|---|---|---|---|
| | PARAMETERS | | | CONDITIONS | | CONDITIONS | | | |
| | STARTER | | | AT START | | AT END | | viscosity | |
| TRIAL | CULTURE | Temp | Time | COUNTS | pH | COUNTS | pH | mPas/sec | remarks |
| | S. thermophilus | 37° C. | 3 h | 3.7 × 10⁶ | 6.66 | 6.6 × 10⁶ | 4.47 | 60 | Excellent |
| | BS5 | | 45 m | | | | | | flavour, |
| | L. acidophilus | | | 3.2 × 10⁷ | | 4.75 × 10⁷ | | | creamy |
| | BL228 | | | | | | | | |

### EXAMPLE 4

### Obtaining Fermented Products Starting from Orgeat of Chufa

The high concentration of sugars present in chufa orgeat constitutes an excellent fermentable substrate for lactic bacteria and bifidobacteria. Due to possessing a low concentration of proteins (Table 3), the viscosity will have to be achieved by production of bacterial exopolysaccharides and/or by addition of stabilisers and gelling agents. The high concentration of starches in chufa orgeat prevents the use of heat treatments beyond 72° C. without causing gelling. This requires additional treatments such as settling or the use of amylolytic enzymes prior to the heat treatment.

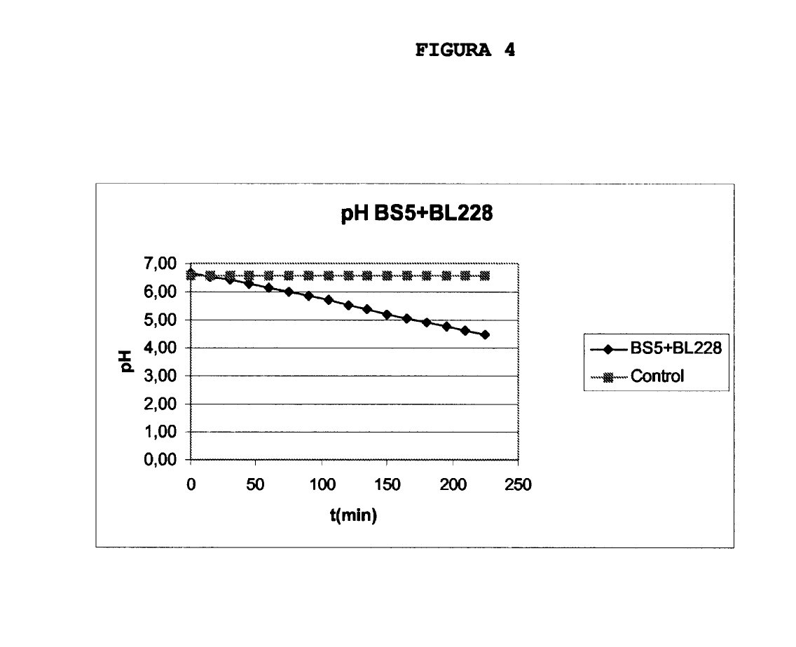

For the fermentation trial, we take a commercial UHT chufa orgeat (Frixia, Industrias Lácteas Morais, S.A.) with the following ingredients: water, chufa, sugar, emulsifier (E472, E471), natural flavourings, cinnamon and lemon. To this product inoculi of St. salivarius subsp thermophilus BS5 and L. acidophilus BL228 were added and it was incubated at 37° C. (FIG. 4). After incubating for 3 h and 45 minutes, a suitable drop in pH (pH=4.47) was achieved, with a product being obtained that had a creamy appearance (viscosity 60 mPas) and excellent flavour (Table 6). Although the inoculated bacteria did not manage to proliferate in the orgeat as in other substrates, it was indeed shown to be metabolically very active, as deduced from the drop in pH.

### EXAMPLE 5

### Fermented Products Pasteurised with “Bifidus Effect”

This application would have a fair degree of importance and would give rise to FERMENTED PASTEURISED PRODUCTS WHICH WILL NOT REQUIRE COLD CHAIN by starting from any of the above examples and adding a pasteurisation stage following fermentation. . . . This particular embodiment is carried out starting from the above examples to which are added, among other additives, oligofructosaccharides or different starches of slow use (in order to achieve the “BIFIDUS EFFECT”) to the almond milk mother liquor, adjusting its concentration, and also that of other gelling agents (the oligofructosaccharides have thickening properties on their own) in order to obtain the desired viscosity. In this case, the initial fermentation will be carried out at least with one strain of S. salivarius subsp. thermophilus and afterwards the product is pasteurised, being left ready for marketing. Although this product will lack lactic ferments and live probiotics, it will contribute major logistic and marketing advantages.

1) Product fermented without lactose wherein it is obtained starting from a milky solution (blended in water) (homogenised in water) of tree nuts and/or chufa orgeat as substrate for the fermentation, using as ferment lactic bacteria, bifidobacteria or other microorganisms alone or in combination and the finished fermented product presents a texture and viscosity equivalent to that of traditional yoghurt or of drinkable yoghurts or fermented drinks.

2) Product fermented without lactose according to claim 1, wherein it does not contain milk, lactose, soy, or any of their components.

3) Product fermented without lactose according to claim 1, wherein added to the fermentation substrate as adjuvant substrates are various kinds of sugars or carbohydrates, for example, mono- and disaccharides (such as glucose, fructose and saccharose).

4) Product fermented without lactose according to claim 1, wherein the fermentation substrate is almond milk.

5) Product fermented without lactose according to claim 1, wherein the fermentation substrate is hazelnut milk.

6) Product fermented without lactose according to claim 1, wherein the fermentation substrate is chufa orgeat (drink of Cyperus sculentus).

7) Product fermented without according to claim 1, wherein the fermentation substrate is a mixture of substrates.

8) Product fermented without lactose according to claim 1, wherein the ferment comprises the species of lactic bacterium Streptococcus salivarius subsp. thermophilus.

9) Product fermented without lactose according to claim 1, wherein the ferment comprises the species of lactic bacterium Lactobacillus delbruekii subsp. bulgaricus.

10) Product fermented without lactose according to claim 1, wherein the ferment comprises any of the species of bifidobacteria as probiotics Bifidobacterium lactis, Lactobacillis casei and Lactobacillus acidophilus.

11) Product fermented without lactose according to claim 1, wherein the ferment comprises any of the species of bifidobacteria as probiotics Lactobacillus rhamnosus, Lactobacillus johnsonii, Lactobacillus fermentum or Lactobacillus reuteri.

12) Product fermented without lactose according to claim 1, wherein the ferment comprises the inoculum kefir or any of its components.

13) Product fermented without lactose according to claim 1, wherein carbohydrates and proteins and additives can be added or fats and oils can be eliminated in order to obtain products possessing very diverse physico-chemical, nutritional and sensorial products or products with improved conservation.

14) Product fermented without lactose according to claim 13, wherein different types of sugars or carbohydrates are added on account of their sweetening, dietetic or functional properties.

15) Product fermented without lactose according to claim 14, wherein the sugars or carbohydrates are dietetic fibre or oligosaccharides with bifidogenic effect.

16) Product fermented without lactose according to claim 13, wherein artificial sweeteners or non-metabolisable sugars such as fructose or sorbitol are added.

17) Product fermented without lactose according to claim 13, wherein carob gum, xanthan gum, acacia gum, maize starch, carragenate and/or pectin are added as gelling agents, thickeners or stabilisers.

18) Product fermented without lactose according to claim 13, wherein amylolytic enzymes are added in order to prevent the occurrence of gelling during the heat treatment.

19) Product fermented without lactose according to claim 13, wherein supplements are added in order to enrich these products with certain minerals (Fe, Ca) and vitamins.

20) Product fermented without lactose according to claim 1, wherein the final fermented product possesses live bacteria which, after 28 days of storage at refrigeration temperature, contains at least 10⁶ cfu/ml, has acidity (pH<4.6), with viscosity values between approximately 60 and 250 mPas/sec, and the coliform counts are zero.

21) Product fermented without lactose according to claim 20, wherein the final fermented product possesses low post-acidification, in other words, the pH drops by less than 0.2 pH units in 28 days.

22) Product fermented without lactose according to claim 1, wherein the final fermented product is pasteurised following fermentation, maintaining its inherent characteristics of acidity (pH<4.6), with viscosity values between approximately 60 and 250 mPas/sec, and the coliform counts are zero.

23) Method for obtaining a product fermented without lactose according to claim 1, wherein it comprises the following stages:
coarse crushing of the substrate (optional),
addition of water,
addition of sugars,
addition of additives (this addition can optionally be done later),
fine grinding, with a stone or colloidal mill until a suspension is obtained with a texture that is from smooth to lumpy,
adjustment of the concentration of dry matter
removals of fats,
homogenization until a uniform size of fat particles in suspension is achieved,
heat treatment of pasteurisation or sterilisation (the conditions of temperature, time and pressure will depend on the nature of the substrate, on the size of particles in the suspension, its concentration of solids, viscosity, microbiological load prior to treatment and stability of components to the heat treatment),
addition of ferments,
fermentation at between 37 and 42° C. until a pH<4.6 is achieved, and refrigeration in order to halt the fermentation.

24) Method for obtaining a product fermented without lactose according to claim 23, wherein after the fermentation a subsequent pasteurisation is carried out in order to obtain pasteurised products after the fermentation which do not require refrigeration and have a useful life of more than 28 days.
